(19) United States
(12) Patent Application Publication
(10) Pub. No.: US 2010/0109961 A1
(43) Pub. Date: May 6, 2010

(54) Transponder label on an electrically conductive surface and method for placement of a transponder label onto an electrically conductive surface

(76) Inventor: Reinhard Surkau, Fuerstenfeldbruck (DE)

Correspondence Address: COLLARD & ROE, P.C., 1077 NORTHERN BOULEVARD, ROSLYN, NY, 11576, US

(21) Appl. No.: 12/590,102

(22) Filed: Nov. 2, 2009

(30) Foreign Application Priority Data
Nov. 3, 2008 (EP) 08168224.7

(51) Int. Cl. H01Q 13/10; B32B 37/12; B32B 38/00

(52) U.S. Cl. 343/767; 156/60; 156/280

(57) ABSTRACT

A transponder label on a metallic base surface has a slit-shaped recess in an electrically conductive surface to form a slit antenna that is used as the antenna for the transponder label. The metallic base surface also possesses a slit that is adapted to the slit of the slit antenna. The transponder label is affixed to the base surface in such a manner that improved transmission and reception properties are achieved.

### CROSS REFERENCE TO RELATED APPLICATIONS

Applicant claims priority under 35 U.S.C. §119 of European Application No. 08168224.7 filed on Nov. 3, 2008.

### BACKGROUND OF THE INVENTION

1. Field of the Invention

The invention relates to a transponder label on an electrically conductive surface and method for placement of a transponder label onto an electrically conductive surface.

2. Description of the Related Art

Nowadays, transponder labels are used in many different areas. A transponder label is understood to be an arrangement consisting of a carrier material, on which a transponder chip or a module having a transponder chip together with an antenna is affixed. The carrier material may be, for example, a plastic film.

Transponder labels are frequently affixed to work pieces, in order to control an automatic production process. For example, they are used on production lines. In this connection, a data exchange takes place between the machining tools or stations and the work piece, by way of the transponder label. The data between the production line and the data exchange label are frequently transmitted by way of high-frequency signals. If a transponder label lies close to the surface of an electrically conductive material, the data exchange is significantly impaired.

In order to reduce impairments caused by an electrically conductive surface, WO 01/078002 describes a transponder label that is disposed on a dielectric base or on a part that can be set up. The transponder label is affixed at a sufficient distance from the metal surface of the work piece. In this way, the negative influences caused by the metal surface are eliminated or at least reduced.

In DE 102006029249 A, a block-shaped transponder is described, which is to be attached to a metallic flat object provided with a slit. The transponder projects through the slit and requires a lot of space, so that a flat method of arrangement is not possible. In this connection, the transponder chip is connected with the metal object in electrically conductive manner, i.e. there is galvanic coupling between the chip and the metal.

Such arrangements of transponders on metallic surfaces require a relatively large-volume construction. It is not possible to affix such voluminous arrangements in all areas of application. Furthermore, the optics of the objects provided with such transponder arrangements are also negatively influenced in this way.

DE 102006051902 A discloses an arrangement of a transponder on a metallic object that has a sensor coil. Three variants are indicated for affixing the transponder on an object: (1) placing a sensor coil on a surface of the metal part in the region of the closed end of a slit that extends from an edge of the metal part into the interior; (2) placing the sensor coil in the center of a free edge of the metal part, in such a manner that the cross-section surface of the sensor coil overlaps the free edge; (3) placing a transponder chip having two connection flags over a continuous slit, whereby the connection flags of the transponder chip are affixed, in electrically insulating manner, on both sides of the slit.

In this connection, very precise placement of the relatively small transponder chip on the corresponding metal part is required. Such placement is hardly possible for an inexpert person with the required precision. For this reason, these transponder arrangements are not suitable for affixing transponders that are to be affixed to a metal surface of a work piece by a user of average skill. Furthermore, such transponder arrangements can be checked, in production, only with a relatively great amount of inspection effort, thereby raising the production costs.

It is therefore desirable to provide an arrangement of a transponder label on an electrically conductive surface that is simple to implement and can also be quickly implemented by an inexpert user.

### SUMMARY OF THE INVENTION

According to one embodiment, a transponder arrangement for operating a transponder label on an electrically conductive base surface is made available. This transponder arrangement comprises a transponder label having a dielectric carrier layer, a transponder chip, and a slit antenna that is formed as a slit-shaped recess in an electrically conductive layer. The transponder label is disposed on an electrically conductive base surface that also comprises a slit-shaped recess, which is adapted to the slit-shaped recess of the slit antenna.

According to another embodiment, a method for the production of a transponder arrangement on an electrically conductive surface is made available. For this purpose, a slit antenna is disposed on a dielectric carrier layer. A transponder chip is affixed to the slit antenna. Furthermore, the carrier layer, with the slit antenna and the transponder chip, is affixed to the electrically conductive base surface, the electrically conductive base surface having a slit-shaped recess that is adapted to the recess of the slit antenna.

According to one embodiment, a transponder label is to be disposed on a metal surface having a recess, whereby the recess of the metal surface is adapted to the shape of the antenna of the transponder label.

The transponder label of the present embodiment can be affixed, in particularly simple and user-friendly manner, on a metal object or on another electrically conductive element. Although conventional transponder labels cannot be used on metal surfaces, or can be used only with great difficulty, the arrangement of the present invention demonstrates improved transmission and reception properties.

For the embodiments, in this connection, the metal parts can also be produced from a non-metallic electrically conductive material. For example, compounds that contain carbon, or a conductive polymer, are possible. For this reason, in the following, the term metal/metallic should also be understood to mean any other electrically conductive material or a material coated with an electrically conductive substance.

By using a transponder label having a slit antenna, it is possible to produce labels having a very low construction height. These labels can first be imprinted or processed in some other manner, just like all other conventional labels. Such a transponder label can furthermore be applied, in simple manner, to a suitable location on the metal surface. Thus, using the transponder label arrangements according to the invention provides numerous advantages both with regard to the data transmission quality and with regard to user friendliness in applications.

Preferably, the shape of the slit-shaped recess of the electrically conductive base surface agrees with the shape of the slit-shaped recess of the slit antenna.

In a preferred embodiment, the slit-shaped recess of the electrically conductive base surface and the slit-shaped recess of the slit antenna overlap completely or at least partially. In this manner, particularly good transmission and reception results can be achieved for the transponder label arrangement on a metal surface.

Preferably, the slit antenna has a straight-line edge from which the slit-shaped recess proceeds, and the straight-line edge of the slit antenna runs parallel to a straight-line edge of the electrically conductive surface. In this way, a further improvement of the transmission properties of the transponder arrangement can be achieved.

According to a preferred embodiment, the slit antenna and the electrically conductive base surface are galvanically separated. In this case, the electrically conductive base surface can serve as an ancillary or secondary antenna, and allow a further improvement in the transmission and reception properties.

Alternatively, the slit antenna and the electrically conductive base surface can be galvanically connected with one another. In this case, as well, excellent transmission quality can be achieved.

Preferably, the carrier layer possesses an adhesive coating. In this manner, the prepared transponder label can quickly and easily be applied to the electrically conductive surface.

In a preferred embodiment, the transponder arrangement furthermore has a protective layer on top of the slit antenna and the transponder chip. In this way, the structure underneath the protective layer is protected against damage, particularly damage as the result of mechanical impairment. In addition, the protective layer can also be imprinted or labeled, and thus can serve as a carrier for optical information. The protective layer can consist of one or more films having similar plies, or of a mass that is applied in liquid form. In other words, over-casting as well as forming methods such as injection molding can be used.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an arrangement of a transponder label according to a first embodiment of the invention;

FIG. 2 shows an arrangement of a transponder label having an alternative transponder antenna;

FIG. 3 shows an arrangement of a transponder label having other optional embodiment characteristics of the present invention; and

FIG. 4 shows a usage example of the transponder arrangement according to the invention.

### DETAILED DESCRIPTION OF THE PREFERRED EMBODIMENTS

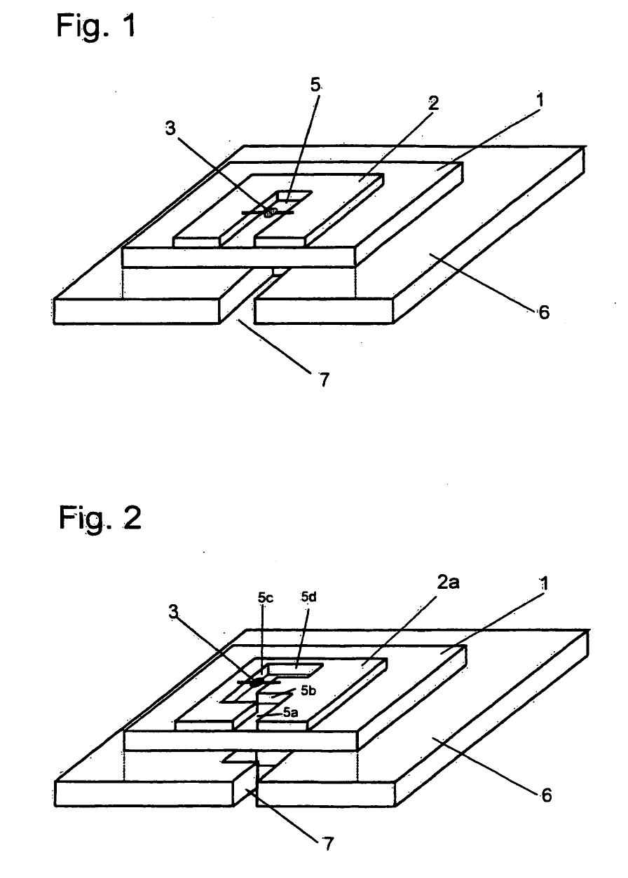

Referring now in detail to the drawings, FIG. 1 shows a carrier layer 1 composed of an electrically non-conductive, dielectric carrier material. As an example, plastic in the form of a plastic film can be used as the material for such a carrier layer. Alternatively, the carrier layer can be produced from paper, paperboard, or another dielectric material.

On carrier layer 1, there is an antenna 2 composed of an electrically conductive material, preferably a metal. In this exemplary embodiment, a slit antenna is used as antenna 2. Such an antenna has a surface in which a slit-shaped recess 5 is made. Preferably, a metal foil, such as an aluminum foil, for example, is used for slit antenna 2. A transponder chip 3 is situated on this slit antenna 2. Transponder chip 3 can be coupled with antenna 2 either galvanically or capacitatively, in other words in electrically conductive or insulating manner.

A transponder label structured in this way, composed of carrier layer 1 and antenna 2 with transponder chip 3, is applied to an electrically conductive surface 6 having a slit-shaped recess 7. This electrically conductive surface 6 is referred to as the base surface in the following. Preferably, the base surface is a metal surface, for example a sheet of metal. Other electrically conductive materials, such as conductive plastics, for example, materials that contain carbon, or similar materials, are also possible for base surface 6.

For the structure of the transponder arrangement according to the invention, base surface 6 should be at least as large as slit antenna 2 with transponder chip 3. In this connection, the base surface can have precisely the same dimensions, in length and width, as slit antenna 2. A base surface having larger dimensions in length and/or width than slit antenna 2 is possible, however, and might be more advantageous for radio frequency identification (RFID) signal transmission.

Slit-shaped recess 7 and the slit 5 of slit antenna 2 possess at least approximately the same geometric shape. The transponder label is applied to base surface 6 in such a way that slit 5 of slit antenna 2 at least approximately covers recess 7 of base surface 6. Particularly good transmission and reception properties can be achieved if slit 5 of slit antenna 2 and recess 7 of base surface 6 have an identical shape and/or if slit 5 and recess 7 come to lie precisely on top of one another.

For RFID applications in the ultra high frequency (UHF) sector, slit antennas having a slit width of a few millimeters have particularly proven themselves. Preferably, the slit of such a slit antenna possesses a width of 2 mm to 4 mm. In order to achieve particularly good transmission and reception results, a similar, preferably identical configuration should be selected for slit-shaped recess 7 in base surface 6.

For slit antenna 2, a metal foil is preferably used, in which a slit extends into the interior from a straight-line edge at the rim of the metal foil. Preferably, an electrically conductive base surface in the shape of a rectangle is chosen for slit antenna 2. In particular, the slit antenna can possess a square shape. For such a transponder label, particularly good results can be achieved if the straight-line edge of the transponder label at least approximately agrees with a straight-line edge of base surface 6 that lies underneath it. Ideally, the two edges run parallel to one another.

A base surface 6 that, in addition to the straight-line first edge described above, comprises a second edge that precisely or at least approximately runs perpendicular to the first edge, has proven to be particularly advantageous. A secondary antenna effect is expanded by means of this second edge. In this way, excellent omnidirectionality for transmission and reception properties is achieved for the transponder arrangement, in interplay with base surface 6.

FIG. 2 shows an embodiment of the present invention, having a different embodiment of the transponder antenna. In contrast to the straight-line progression of the slit, here a slit antenna 2a having an arched progression of slit 5 is used as the transponder antenna. A first part 5a of the slit runs from an edge of the metal foil, at first at least approximately perpendicular to the edge, into the interior of the metal foil. This first part 5a is followed by a second part 5b of the slit, which extends approximately parallel to the edge of the slit antenna. A third part 5c of the slit again runs in the same direction as the first part 5a of the slit, and a fourth part 5d of the slit runs in the same direction as the second part 5b of the slit. In this way, a slit antenna 2a having a slit whose shape is reminiscent of the shape of a question mark is obtained.

Excellent impedance adaptation between slit antenna 2a and transponder chip 3 that is used can be achieved by means of suitably selecting the position of transponder chip 3 in one of the partial regions 5a-5d.

For the structure according to the invention, it is required that base surface 6 on which a transponder label having slit antenna 2, 2a described above is affixed possesses an at least similar slit-shaped recess 7. Ideally, slit 5 of slit antenna 2, 2a and recess 7 in base surface 6 that lies underneath it agree precisely in shape and/or position.

Aside from the straight and arched recesses in the slit antenna and the base surface that lies underneath it, other shapes are also possible for recesses 5 and 7.

Even if ideally the slit of slit antenna 2, 2a and recess 7 of base surface 6 that lies underneath it should agree as precisely as possible for optimal transmission and beginning performance of a structure of a transponder label on a metal surface as described above, excellent results can nevertheless still be achieved even in case of slight deviations in shape and/or position. For this reason, such a structure, in which a pre-finished transponder label is generally affixed to a prepared base surface, can be easily and quickly implemented even by an inexpert person. Neither extensive instruction of the person performing the task nor any special, expensive tools for such a structure are required.

A transponder label produced in this manner is not dependent on an electrically conductive base surface. Even before being applied to the base surface, it can be detected and read out. In this manner, the label can be checked directly after production, for example. Thus, very fast and cost-advantageous quality control is possible.

Because the electrically conductive base surface is not absolutely necessary for the function of the transponder label, the label can also be affixed to non-conductive surfaces. Thus, this transponder label is one that can be used very universally.

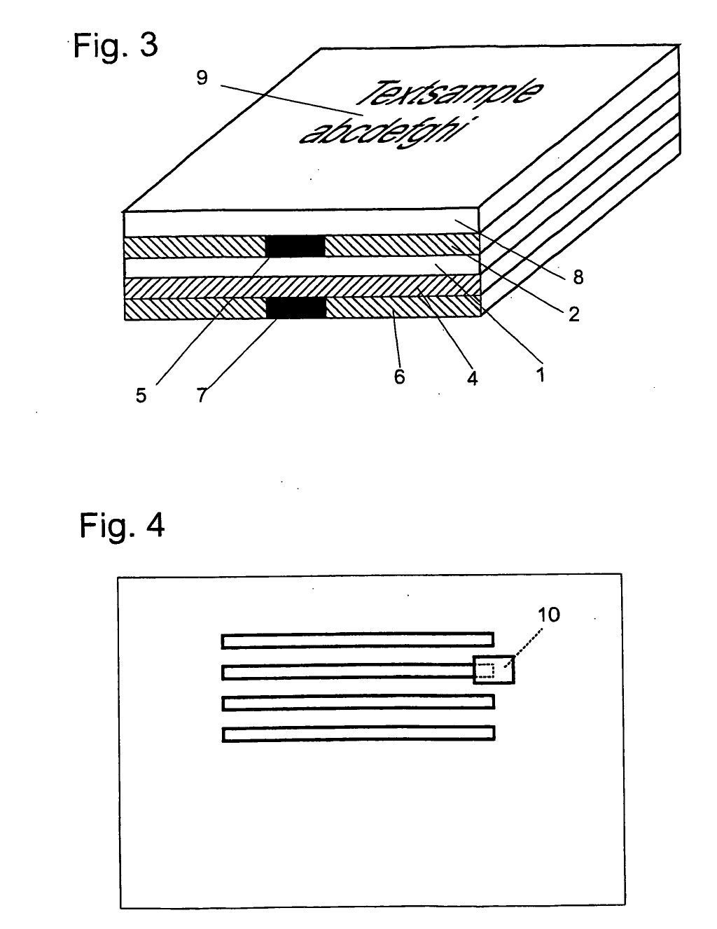

In order to further simplify the production of such a transponder label structure, and to protect the structure both during production and in later operation, numerous other embodiments are possible, such as those shown in FIG. 3, for example. These additional options are possible both individually and in a suitable combination.

For example, an adhesive layer 4 can additionally be applied under the dielectric carrier layer 1. In particular, so-called adhesive adhesives are possible for the adhesive coating. In this way, during production of the transponder structure according to the invention, the transponder label can be quickly and easily connected with the prepared base surface 6, without special work steps being required for joining them together.

In order to protect the entire structure, particularly transponder chip 3 on the antenna, from damage, a protective film 8 can be applied over transponder antenna 2 and transponder chip 3. Alternatively, the structure can also be provided with a plastic top casting or plastic encasement casting. In this way, the prepared transponder label is protected from damage, in simple manner, before it is joined together with metal surface 6, on the one hand, and during subsequent operation.

Preferably, protective film 8 is an opaque film, for example a white film. This film can also be provided with additional inscriptions 9. In this way, the structure can also be optically identified, for example, so that a user can derive information from the label even without an RFID reader. Such an imprint can be over-cast transparently afterward. In this way, optical readability is implemented, with simultaneous high-strength protection of the transponder electronics. Furthermore, the user can also be given assistance in positioning the label on the slit-shaped recess of metal surface 6 by means of suitable imprints. In this way, the user can quickly and easily affix the prepared transponder label to the metal surface, and thus obtain a structure according to the invention.

Particularly good protection of the transponder label can be achieved in that the electrical carrier layer 1 and the protective film 8 completely enclose both transponder antenna 2 and transponder chip 3, and, in this connection, no slit-shaped recesses of any kind are present in the carrier layer and protective film.

Recess 7 in metal surface 6 can additionally be filled with a dielectric filler, for example with a plastic, resin, wax, etc. Also, the transponder label can be configured in such a manner that part of the carrier film and/or protective film at first projects beyond the rim of the edge of a base surface in the manner of a metal sheet, when it is affixed, and then covers the slit by being bent around the sheet-metal-like structure. In this way, not only is the optical appearance improved, but also increased stability and, if necessary, a tight seal of the marked object are achieved.

Alternatively, however, recess 7 can also remain partly or completely clear.

It is also possible to also introduce a slit, at least partially, into carrier layer 1 and protective film 8, and thus to cover the slit of the base surface of the slit object situated underneath it as little as possible. This arrangement can be particularly advantageous if a slit that is also supposed to fulfill other functions, such as a cooling opening, for example, is used as a recess 7 in the metal object. Nevertheless, even in this case, it is a good idea to cover the slit of the slit antenna with carrier layer 1 and protective film 8 at least to such an extent that transponder chip 3 is protected by them.

In this connection, FIG. 4 shows a structure 10 having a transponder label, as an example, on a ventilation grid of a metal housing. This ventilation grid can be the ventilation grid of an electrical device, for example a refrigerator or a power supply. Of course, all other slit-shaped recesses on electrically conductive surfaces are suitable for the structure according to the invention. If the metal surface does not already possess suitable slit-shaped recesses on its own, as the result of its design, then almost any metallic surface can be prepared for the structure of a transponder label arrangement according to the invention by means of producing such a recess.

Furthermore, it is also possible to represent the transponder function by way of an additional metal sheet that is additionally affixed. This metal sheet can have optimal dimensions for RFID detection, and can serve as an omnidirectionally detectable transponder arrangement, free-standing at a suitable location.

In summary, the present invention describes a structure of a transponder label on a metallic base surface. A slit-shaped recess in an electrically conductive surface, i.e. a slit antenna, is used as the antenna for the transponder label. The metallic base surface also possesses a slit that is adapted to the slit of the slit antenna. In this connection, the transponder label is affixed to the base surface in such a manner that excellent transmission and reception properties can be achieved.

Accordingly, although only a few embodiments of the present invention have been shown and described, it is to be understood that many changes and modifications may be made thereunto without departing from the spirit and scope of the invention.

What is claimed is:

1. A transponder arrangement for operating a transponder label on an electrically conductive surface comprising:
(a) a transponder label having a dielectric carrier layer, a transponder chip, and a slit antenna comprising an electrically conductive layer and a slit-shaped recess in the electrically conductive layer; and
(b) an electrically conductive base surface;
wherein the electrically conductive base surface comprises a slit-shaped base surface recess adapted to the slit-shaped recess of the slit antenna.

2. The transponder arrangement according to claim 1, wherein the slit-shaped base surface recess and the slit-shaped recess of the slit antenna at least partially overlap.

3. The transponder arrangement according to claim 1, wherein the slit-shaped base surface recess has a first shape and the slit-shaped recess of the slit antenna has a second shape matching the first shape.

4. The transponder arrangement according to claim 1, wherein the slit antenna has a first straight-line edge, the electrically conductive base surface has a second straight-line edge, the slit-shaped recess extends from the first straight-line edge, and the first straight-line edge extends parallel to the second straight-line edge.

5. The transponder arrangement according to claim 1, wherein the slit antenna and the electrically conductive base surface are mounted galvanically separated from one another.

6. The transponder arrangement according to claim 1, wherein the carrier layer has an adhesive coating.

7. The transponder arrangement according to claim 1, comprising a protective layer over the slit antenna and the transponder chip.

8. A method for producing a transponder arrangement on an electrically conductive base surface comprising the steps of:
(a) affixing a slit antenna having a slit-shaped recess in an electrically conductive layer onto a dielectric carrier layer;
(b) affixing a transponder chip to the slit antenna; and
(c) affixing the carrier layer with the slit antenna and the transponder chip to the electrically conductive base surface;
wherein the electrically conductive base surface has a base surface recess adapted to the slit-shaped recess of the slit antenna.

9. The method according to claim 8, wherein the base surface recess has a first shape and the slit-shaped recess of the slit antenna has a second shape matching the first shape.

10. The method according to claim 8, wherein the step of affixing the carrier layer with the slit antenna and the transponder chip onto the electrically conductive base surface disposes the carrier layer so that the slit-shaped recess of the slit antenna and the base surface recess of the electrically conductive base surface at least partially overlap.

11. The method according to claim 8, wherein the step of affixing the carrier layer with the slit antenna and the transponder chip onto the electrically conductive base surface disposes the carrier layer so that the slit-shaped recess of the slit antenna and the base surface recess of the electrically conductive base surface overlap completely.

12. The method according to claim 8, wherein the slit antenna has a first straight-line edge, the slit-shaped recess extends from the first straight-line edge, and the carrier layer is affixed onto the electrically conductive base surface so that the first straight-line edge of the slit antenna extends parallel to a second straight-line edge of the electrically conductive base surface.

13. The method according to claim 8, wherein the slit antenna is affixed to the electrically conductive base surface in a galvanically separated manner.

14. The method according to claim 8, wherein the carrier layer is glued onto the electrically conductive base surface.

15. The method according to claim 8, further comprising applying a protective layer over the slit antenna and over the transponder chip.
